(19) United States
(12) Patent Application Publication
(10) Pub. No.: US 2008/0222065 A1
(43) Pub. Date: Sep. 11, 2008

(54) LEARNING AND ANALYSIS SYSTEMS AND METHODS

(75) Inventors: David Kedrowski, Eden Prairie, MN (US); Elaina Shekhter, Eagan, MN (US)

Correspondence Address: FOGG & POWERS LLC, 10 SOUTH FIFTH STREET, SUITE 1000, MINNEAPOLIS, MN, 55402, US

(73) Assignee: SHARKBAIT ENTERPRISES LLC, Eagan, MN (US)

(21) Appl. No.: 11/682,167

(22) Filed: Mar. 5, 2007

(51) Int. Cl. G06F 15/18; G06N 3/08

(52) U.S. Cl. 706/19; 706/25

(57) ABSTRACT

A system that automatically generates problem-specific neural networks for each of a plurality problems associated with an analyzed environment when there is sufficient data to do so for each such problem and that, in connection with generating a solution for each of the plurality of problems, selects which of the problem-specific neural networks associated with that problem to use in order to produce the solution. The system also retrains each neural network when appropriate. The system also generates new neural networks for each problem when it is appropriate to do so. In one implementation, a genetic algorithm is used to generate the new neural networks.

### BACKGROUND

Analytical systems (including, for example, decision-support system, expert systems, and the like) are typically used for analyzing a system, environment, or phenomena (also referred to here as the “analyzed environment”) and generating a recommendation, proposed action, or other output for a given set of inputs. Such analytical systems typically use a solution algorithm that is defined “offline” with reliance on heavy human input. The solution algorithm is typically static and will always produce the same output for the same set of inputs. In other words, the solution algorithm used in such systems is not dynamic and is typically only modified periodically in a manual, offline process. Also, the classifications and parameters used in such solution algorithms (and the interaction, ordering, and weighting of such parameters) are static and manually defined. Moreover, in such systems, the input data typically needs to be gathered, prepared, and scrubbed to remove erroneous data because such systems are typically need “clean” data and do not do well with “noise” in the data. Such systems typically provide no or only a limited feedback mechanism to determine if the solution algorithm is working or not, and such a determination is typically only made (if at all) manually during an offline process.

Furthermore, such systems typically do not provide any mechanism to automatically adapt when the analyzed environment changes during run-time (which is typically the case.) Also, the level of analysis used in such systems is typically predetermined and static and there is no mechanism for auto “flexing”. For example, such a system might determine inventory levels for a retailer's specific product or for a product group but the system will typically not jump back and forth between the two. So, if a retailer has designed a solution algorithm to analyze sales of a blue dress and to generate recommendations related to the blue dress, the solution algorithm will watch the sales of the blue dress and generate recommendations accordingly. However, the solution algorithm will typically not be able to take into account that the color blue for all products is a hot color for a given period of time or that dresses in general are selling more slowly. The retailer, when faced with the poor results of the solution algorithm, may try to manually design a more encompassing solution algorithm but the manual algorithm design effort is very time consuming and the resulting solution algorithm will still be a static algorithm that will not be able to account for all factors, adjust to a shifting environment, or flex between the level needed for analysis. Consequently, such a retailer will try to manually design static solution algorithms for a shifting and moving target and the retailer will often find that once the retailer's algorithm is complete it is no longer valid. And, even if the retailer is somehow successful in designing a successful algorithm for the blue dress problem, the retailer still needs to manually design algorithms for 75,000-200,000 additional items it sells to customers.

Given the time and effort required to design and maintain such conventional systems, such systems are typically designed to attempt to solve one or a very limited subset of the universe of problems that exist within the analyzed environment. However, an action taken with respect to one problem in the analyzed environment may affect other problems within the analyzed environment. For example, if a retailer lowers the price of a first item, the sales of that first item will likely increase; but, sales of a second item might decrease (for example, because the first item and second item are competing products) or the sales of the second item might increase (for example, because there are more people in the store). The ultimate question of, “how do I increase overall sales through optimal item-level pricing and inventory levels” is typically not solved by such conventional systems.

Some conventional analytical systems make use of neural networks. A neural network (also referred to as a “neural net”) comprises a group of nodes (also referred to as “neurons”, “neurodes”, or “processing elements”). Each node receives one or more input signals, for example, from other nodes to which that node is coupled and/or receives one or more external input signals. Each node generates an output signal as a function of a weighted-sum of that node's input signals. Typically, this function often makes use of one or more threshold parameters in generating the output signal. The output signal of a given node is often used as an input to other nodes in the neural network. Each neural network typically comprises an input layer of one or more nodes, zero or more hidden layers of one or more nodes, and an output layer of one or more nodes. Each of the neural networks undergoes a training process using appropriate data. The training processing adjusts the weights assigned to each of the inputs signals in order to be consistent with the data used for training. As used herein, “parameters” refer to the set of inputs that are applied to a given neural network and “predicted results” refer to the one or more outputs of a neural network. Typically, when neural networks are used in analytical system, the neural networks are instantiated and trained in an offline process. Thus, a neural net used in this capacity simply creates a static algorithm no different that any other typical algorithm. If the neural networks need to be retrained (for example, because additional training data has been captured), such retraining also occurs in an offline process and thus there is no real-time learning and adjusting. Additionally, typical neural models are heavily focused on a single problem and great effort is put into refining a specific neural network for that problem. Conventional neural network systems are typically not designed to create, modify, and train hundreds of thousands of neural nets with discrete data sets and with discrete neural net designs (that is, where every one of the hundreds of thousands of neural networks is customized for a particular problem).

Moreover, conventional analytical systems have a difficult time dealing with discontinuous data. Unlike continuous data, which is data that can be scaled, discontinuous data is data that cannot be scaled. One example of continuous data is illustrated in FIG. 1A. In the example shown in FIG. 1A, each element of the data set comprises the age of a particular person. The data in this data set is scalable in that there is relationship that exists between each element of the data set. For example, the elements in the data set can be ordered from youngest to oldest as is shown in FIG. 1A. When a new element is added to the data set, that new element can be easily inserted into the order of the data elements (for example, as shown in FIG. 1A, age 37 is inserted between age 32 and age 41). One example of discontinuous data is shown in FIG. 1B. In the example shown in FIG. 1B, each element of the data set comprises the name of a particular person. In this example, there is no relationship betweens the names of each person that enables the elements in the data set to be ordered. Also, when a new data element is added to the data set, there is no way to insert the new data element into data set. For example, as shown in FIG. 1B, when the name “Lisa” is added to the data set, there is no way to determine where to insert the name Lisa within the data set.

One example of the difficulties of dealing with such discontinuous data is illustrated in FIG. 1C. The example shown in FIG. 1C illustrates the effect of a 2500 calorie diet for various members of a given population. If the resulting effect of such a diet for some members is known, there is typically no way to reasonably predict the result for another member due to the discontinuous nature of the data set. A system analyst has three conventional options for dealing with such a problem. The first option is to use aggregate information. For the example analyzed environment illustrated in FIG. 1C, the system analyst could design a model that takes the average of the people in the known data set. However, this is typically undesirable because it destroys any degree of granularity. A second option is to convert the data into something else. For the example analyzed environment illustrated in FIG. 1C, the system analyst could design a model that classifies each person as male or female for the purposes of making a prediction. However, it may be the case that the system analyst has no reason to believe that a person's sex has an effect on the result of the 2500 calorie diet and such a classification destroys information about a particular person (Lisa in the example shown in FIG. 1C). A third option is to eliminate data. For the example analyzed environment illustrated in FIG. 1C, the system analyst could design a model that only uses data for females. However, this is typically undesirable because less data would be available for the model to analyze and, as with the second option, it may be the case that the system analyst has no reason to believe that a person's sex has an effect on the result of the 2500 calorie diet.

### SUMMARY

In one embodiment, a system is used for analyzing an analyzed environment. The system comprises at least one programmable processor to execute a plurality of program instructions and at least one data storage device communicatively coupled to the at least one programmable processor to store a plurality of neural networks, each of the plurality of neural networks having an associated set of parameters. The program instructions, when executed, are operable to cause the at least one programmable processor to associate a respective plurality of sets of parameters with each of a plurality of problems associated with the analyzed environment. The program instructions, when executed, are further operable to cause the at least one programmable processor to automatically generate a respective neural network for each set of parameters associated with each of the problems when there is sufficient data to do so. The program instructions, when executed, are further operable to cause the at least one programmable processor to generate a solution for at least one problem by selecting a neural network from the neural networks that are associated with the at least one problem and by using a neural network output output by the selected neural network in order to generate the solution for the at least one problem.

In one implementation of such an embodiment, the respective neural network for each set of parameters associated with each of the problems is automatically generated using a genetic algorithm when there is sufficient data to do so. In another implementation of such an embodiment, the respective neural network for each set of parameters associated with each of the problems is automatically generated, when there is sufficient data to do so, by selecting a neural network template, instantiating the respective neural network using the selected neural network template, and training the instantiated respective neural network. In another implementation of such an embodiment, the program instructions, when executed, are further operable to cause the at least one programmable processor to, for each current neural network stored in the at least one data storage device, to automatically generate the respective new neural network and store the respective new neural network in the at least one data storage device in place of the respective current neural network. In another implementation of such an embodiment, the program instructions, when executed, are further operable to cause the at least one programmable processor to, for each current neural network stored in the at least one data storage device, retrain the current neural network and store the respective retrained neural network in the at least one data storage device in place of the respective current neural network. In another implementation, the program instructions, when executed, are further operable to cause the at least one programmable processor to, generate a solution for the at least one problem by selecting, from the neural networks that are associated with the at least one problem, the neural network that has the most appropriate set of parameters associated therewith and that has an associated flex condition that is satisfied, and by using a neural network output output by the selected neural network in order to generate the solution for the at least one problem.

The details of various embodiments of the claimed invention are set forth in the accompanying drawings and the description below. Other features and advantages will become apparent from the description, the drawings, and the claims.

### DRAWINGS

FIG. 1A illustrates one example of continuous data.

FIG. 1B illustrates one example discontinuous data.

FIG. 1C illustrates one example of the difficulties associated with discontinuous data.

FIG. 2 is a block diagram of one embodiment of a learning and analysis system.

FIG. 3A is a block diagram illustrating one embodiment of a problem-class model.

FIG. 3B is a block diagram illustrating the use of a problem-class model of FIG. 3A with a discontinuous problem set.

FIGS. 3C-3D is a block diagram illustrating one example of a simple two-level hierarchy of problems.

FIG. 4 is a flow chart of one embodiment of a method of creating and training a neural network.

FIG. 5 is a flow chart of one embodiment of a method of generating a neural output for a problem.

FIG. 6 is a block diagram illustrating one exemplary of application of the system of FIG. 2 in which the analyzed environment comprises one or more online poker systems.

FIG. 7 is a block diagram illustrating one exemplary of application of the system of FIG. 2 in which the analyzed environment comprises a portfolio of projects.

FIG. 8 is a block diagram illustrating one exemplary of application of the system of FIG. 2 in which the analyzed environment comprises one or more of retail sales, retail profitability, retail inventory, wholesale sales, wholesale profitability, and wholesale inventory.

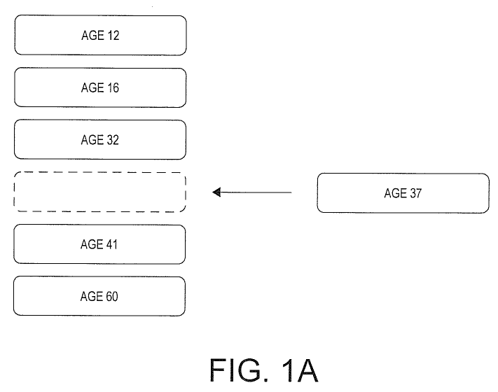

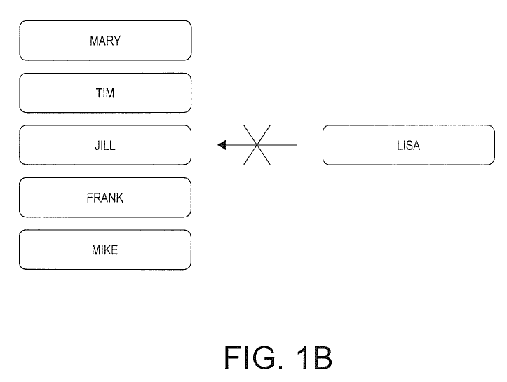

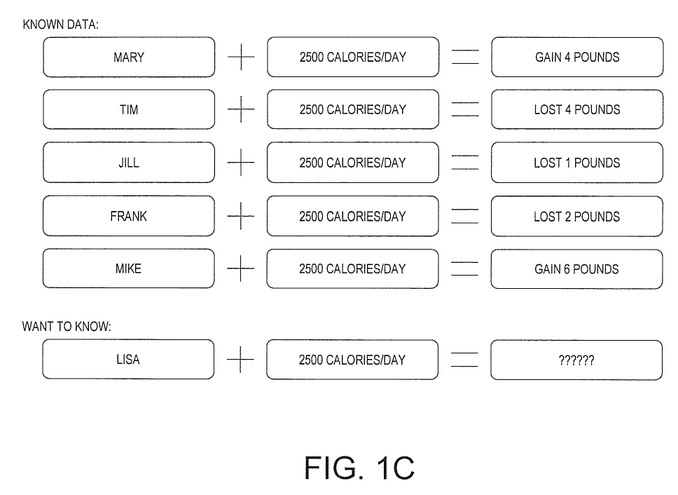

Like reference numbers and designations in the various drawings indicate like elements.

### DETAILED DESCRIPTION

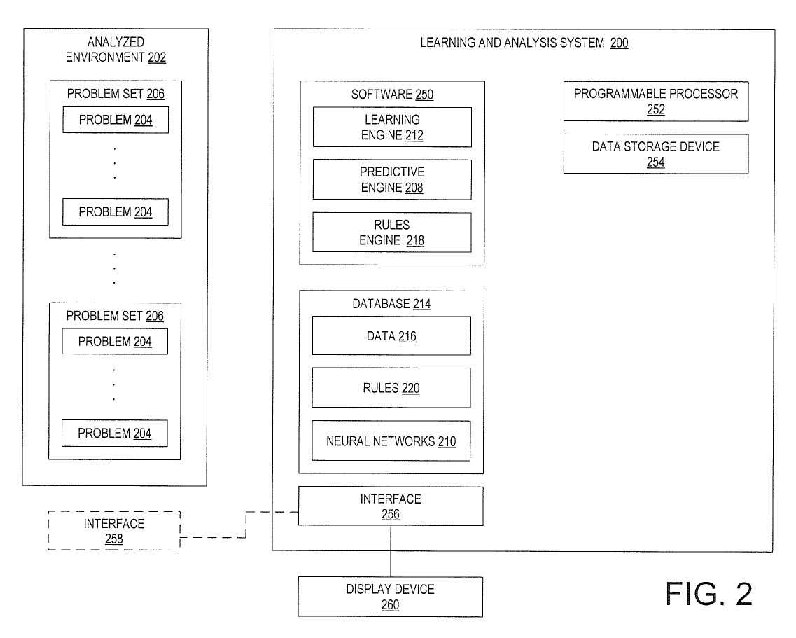

FIG. 2 is a block diagram of one embodiment of a learning and analysis system 200. The learning and analysis system 200 is described here as being implemented as software 250 that executes on one or more computers (though it is to be understood that the system 200 can be implemented using various combinations of hardware and software). In the particular embodiment shown in FIG. 2, the software 250 is executed by at least one programmable processor 252 (for example, at least one general-purpose microprocessor or central processor included in a computer). In another implementation, the programmable processor 252 comprises many (for example, millions of) special-purpose “neural network processors” instead of or in addition to a general-purpose microprocessor or central processing unit. The software 250 comprises a set of program instructions embodied on a storage medium from which at least a portion of the program instructions are read by the programmable processor 252 for execution thereby. The program instructions, when executed by the programmable processor 252, carry out at least a portion of the functionality described here as being performed by the learning and analysis system 200. In such an embodiment, the processor 252 includes or is communicatively coupled to at least one data storage device 254 for storing such program instructions and/or data used during execution of the software 250 (including, for example, the database 214 described below). Examples of suitable data storage devices 254 include any suitable form of volatile memory (such as random-access memory and registers included within programmable processors) and/or non-volatile memory (such as nonvolatile RAM memory, magnetic disc drives, and optical disc drives). Although only a single data storage device is shown in FIG. 2, it is to be understood that multiple data storage device can be used.

The learning and analysis system 200 is used to analyze another system or environment 202, which is referred to here as the “analyzed environment” 202. Generally, the analyzed environment 202 can be any physical or virtual system, environment, or phenomenon that can be modeled as having or involving a plurality of problems 204. As used herein, each problem 204 is characterized as having “solution” or “result” at each point in time. Each of the plurality of problems 204 is a member of a particular problem set 206.

The learning and analysis system 200 further comprises a predictive engine 208 that generates “solutions” for the various problems 204 that exist in the analyzed environment 202. The problems 204 can include both forward-looking problems 204, the solutions to which predict a future state for a respective problem 204, and backward-looking problems 204, the solutions to which provide an explanation, characterization, or insight about a past state for a respective problem 204. How the solutions are generated and used is application dependent. For example, in one application, the solution for a particular problem 204 is used as an input for solving another problem 204 in the analyzed environment 202. In such an application, there are multiple levels of problems 204. Moreover, the techniques used to generate solutions for the various types or levels in the analyzed environment 202 may differ. For example, the techniques described below generate solutions for problems 204 using one or more neural networks. In some applications, solutions are generated for at least some of the problems 204 using conventional rules-based and/or fuzzy-logic techniques (for example, as is typically used in conventional “expert” systems) or game theory. Also, in some applications, the outputs of the neural-network techniques described below are used as inputs to other solution-generating techniques and the outputs of other solution-generating techniques are used as inputs to such neural-network techniques.

For example, in one application, the analyzed environment 202 comprises an on-line poker system that has a plurality of “tables” at each of which a plurality of players play a game of poker. In such an application, there is a separate problem 204 associated with each of the players, the solution or result of which comprises the next game-related action (for example, “hold”, “raise”, “fold”, etc.) that each such player is expected to make based on various game-related attributes (which are considered to be the inputs). In another application, the analyzed environment 202 comprises a travel-related website (for example, an airline, cruise, or hotel reservation system) that a plurality of users access in order to identify and book travel-related offerings (for example, airline flights, cruises, or hotel accommodations).

The system 200, in general, generates an output that is based on at least one solution to one problem 204. For example, at least a portion of such an output may be communicated (via an appropriate interface 256) to a display device 260 for display thereon (for example, using a web browser or other user interface mechanism). Such display device 260 may be local to the system 200 (for example, where a video monitor is coupled directly to a video port of a computer used to implement the system 200) or may be remote to the system 200 (for example, where the display device 260 is a part of or connected to a client computer that remotely accesses the one or more computers used to implement the system 200 over a network such as Internet using appropriate client and server software, in which case the interface 256 comprises an appropriate network interface). In another example, at least a portion of such an output may be communicated via an appropriate interface 256 to an interface 258 associated with the analyzed environment 202 in order to cause an action associated with the analyzed environment 202 to be taken (for example, communicating a command to a system or device associated with the analyzed environment 202 over a network or other communication link that causes the system or device to take some action based on the command). More generally, it should be understood that the output generated by the system 200 is used to (among other things) change the state of the interface 256 (for example, changing the state of the various signals that make up the interface) and any device or interface communicatively coupled thereto (such as display device 260 and interface 258). The interface 256 is also used to capture information related to the analyzed environment 202. Moreover, although only a single interface 256 is shown in FIG. 2, it is to be understood that multiple interfaces (for example, having different types) can be used.

In the embodiment shown in FIG. 2, the predictive engine 208, for at least some of the problems 204, generates a neural network output (also referred to here as a “neural output”) for a given set of set of system inputs using one or more neural networks 210. The learning and analysis system 200 also comprises a learning engine 212 that creates and trains the neural networks 210 used by the predictive engine 208. In the particular embodiment shown in FIG. 2, the learning and analysis system 200 includes or otherwise has access to a database 214 (or other data store) in which the various neural networks 210 and data 216 (including data used to create and train the neural networks 210) are stored.

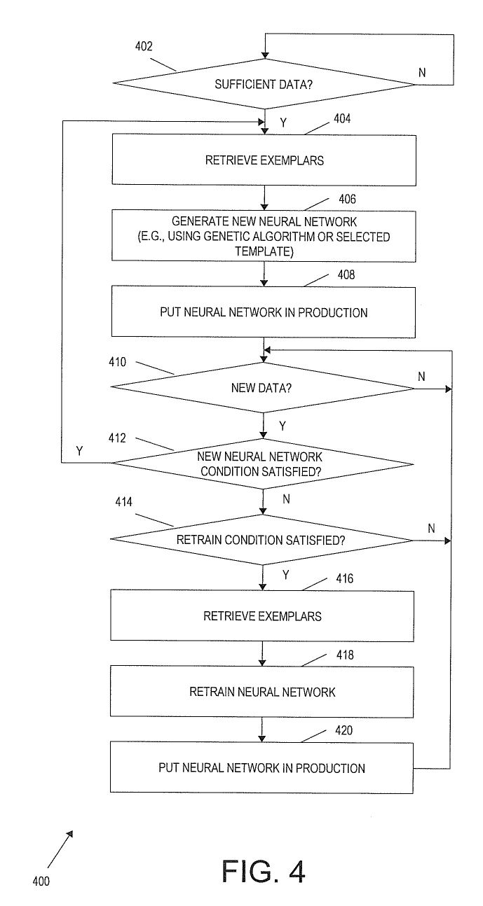

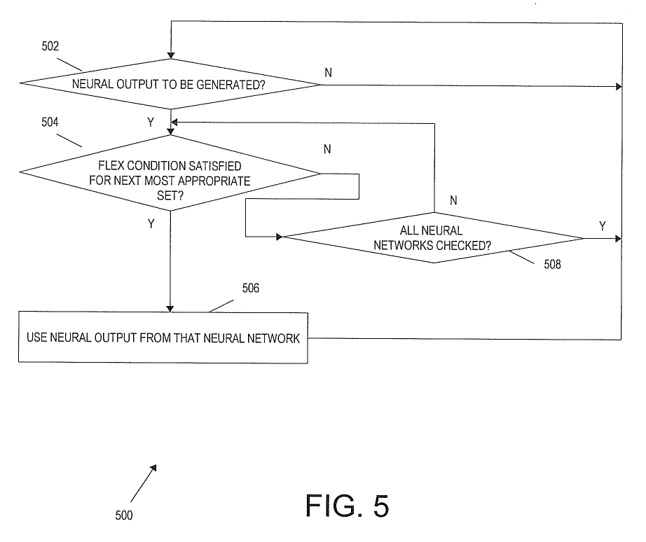

In one embodiment, the neural networks 210 that are used in the system 200 are created using a genetic or evolutionary algorithm. In another embodiment, each of the neural networks 210 that are used in the system 200 is created by selecting an appropriate neural network template, instantiating a neural network using the selected template, and then training the instantiated neural network 210 using the available data. Each problem 204 in the problem set 206 has associated therewith multiple sets of parameters (that is, neural network inputs), each of which has a different level of granularity. For each problem 204, the learning engine 212, when appropriate, generates (and later retrains) a neural network 210 for each set of parameters that is associated with that problem 204 (as described below in connection with FIG. 4). The predictive engine 208, for a given problem 204, selects which output to use from the available neural networks 210 associated with that problem 204 (as described below in connection with FIG. 5).

Embodiments of the system 200 are especially well-suited for use with discontinuous problem sets. Where the system 200 is used with discontinuous problem sets, each problem 204 within a discontinuous problem set 206 is individually solved using one or more neural networks 21 0. The neural networks 210 are specifically created and trained for that problem 204 (for example, using a genetic algorithm as described below), where the parameters that are used as inputs to each such neural network 210 are continuous (that is, scaled). In this way, each problem 204 within such a discontinuous problem set 206 is individually solved using problem-specific neural networks 210 that are created, trained, and retrained “on the fly” (that is, at run time) without human involvement.

The system 200 further comprises a rules engine 218 that controls the configuration and operation of the system 200 in accordance with rules 220 that are also stored in the database 210. For example, the rules 220 specify how the various problems 204 in the analyzed environment 202 are classified and solved and how any neural networks 210 used to solve such problems 204 are created and trained. In one implementation, the rules 220 are created in an off-line process involving human input (for example, by employing an expert in the particular application or problem domain). In another implementation, at least some of the rules 220 that are used in the system 200 are produced (at least in part) using the neural-network techniques described here. In such an implementation, the system 200 is able to automatically adapt to the particular application and environment in which it is used. For example, in such an implementation, the system 200 is able to automatically adjust the level at which system 200 attempts to solve problems by changing not only the neural network topologies and weights but also the makeup of the sets of parameters used by the neural networks 210.

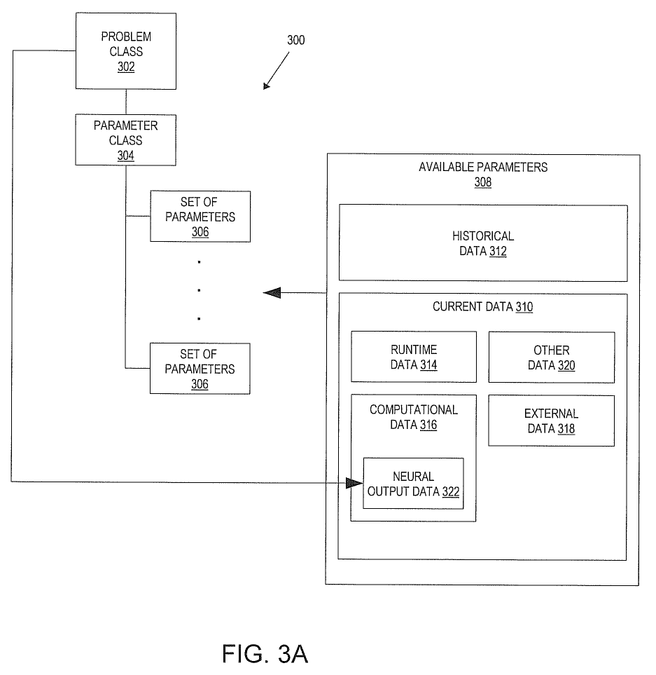

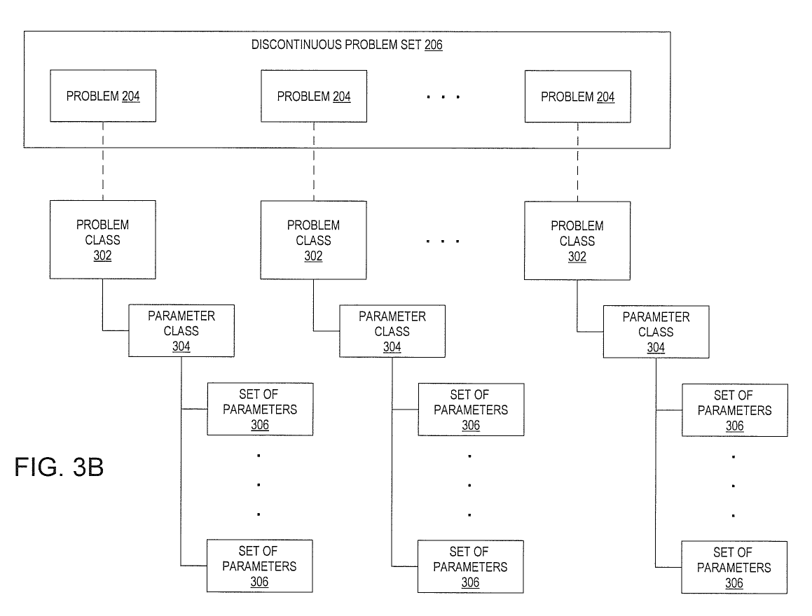

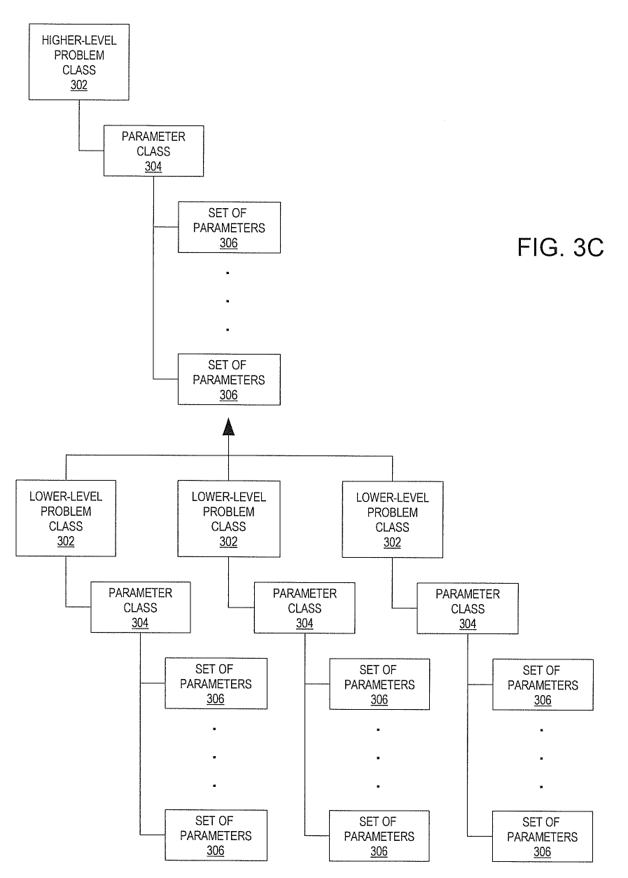

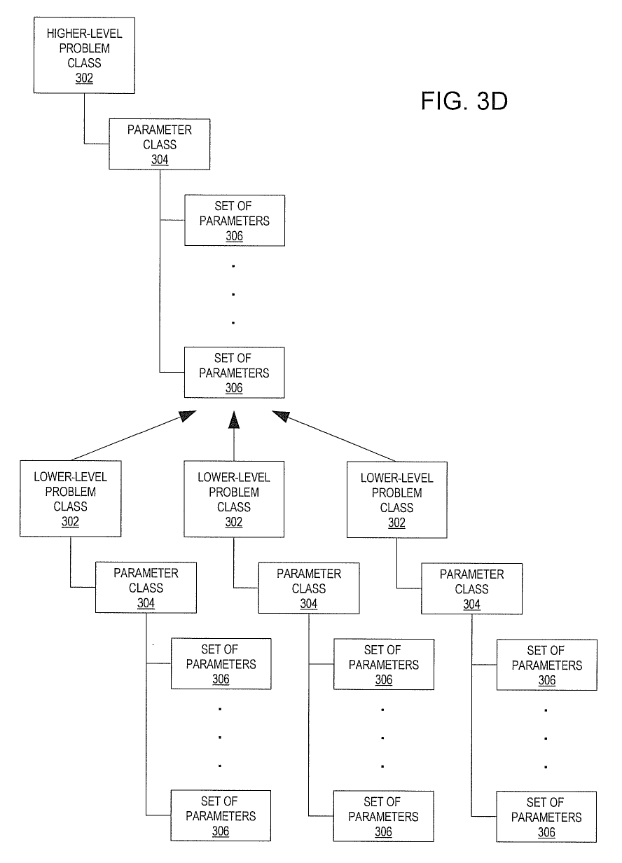

FIG. 3A is a block diagram illustrating one embodiment of a problem-class model 300. The embodiment of the problem-class model 300 shown in FIG. 3A is described here as being implemented using the learning and analysis system 200 of FIG. 2; however, it is to be understood that the model 300 can be used with other systems. In general, an instantiation of the problem-class model 300 is created by the learning engine 212 for each problem 204 in the problem set 206 (for example, at the time the respective problem 204 first occurs in the analyzed environment 202).

The problem-class model 300 identifies information that the learning engine 212 uses to create and train one or more neural networks 210 for a particular problem 204 and that the predictive engine 208 uses to select, at a particular point in time, which neural network's output should be used as a solution to that particular problem.

More specifically, the problem-class model 300 comprises a problem-class identifier 302 that identifies the particular class of problems with which the problem-class model 300 was designed to be used. The class of problems with which the problem-class model 300 was designed to be used is also referred to here as the “problem class” of the model 300. The problem-class model 300, in general, includes information that is used to create and train one or more neural networks 210 for each problem that is within the parameter class associated with the model 300 and that is used to select which neural network's output should be used as a solution to that particular problem. In the embodiment shown in FIG. 3A, the problem-class model 300 comprises a parameter-class identifier 304. The parameter-class identifier 304 identifies a class of parameters (also referred to here as a “parameter class”) to be used with the problem class identified in the problem-class model 300. The parameter class specifies a group of sets of parameters 306 that are used to create a group of neural networks for each problem within the identified problem class. As noted below, each set of parameters 306 is used to create a respective neural network 210 that uses that set of parameters 306 as its inputs (that is, as its parameters). The sets of parameters 306 have different levels of granularity. Generally (though not always), the sets of parameters 306 that are more granular typically require more exemplary data to train an associated neural network 210 but typically produce “better” (that is, more accurate) outputs, while the sets of parameters 306 that are less granular typically require less exemplary data to train an associated neural network 210 but typically produce “worse” (that is, less accurate) outputs. The predictive engine 208, as described below, generally tries to select the neural network output that was output by the neural network 210 having the most appropriate set of parameters (that is, the one that will produce the most accurate overall result or output).

Each set of parameters is selected from the parameters 308 that are available to the learning and analysis system 200 (also referred to here as the “available parameters” 308). In the embodiment shown in FIG. 3A, the available parameters 308 comprise both current data 310 and historical data 312. The current data 310 comprises data about a current state of the analyzed environment 202 or learning and analysis system 200. The current data 310 comprises, for example, runtime data 314, computational data 316, external data 318, and other data 320. Runtime data 314 comprises data captured directly from the analyzed environment 202 or the learning and analysis system 200. In a poker application, for example, runtime data 314 can include data that characterizes the dynamics of the current session or hand (for example, size of the pot). In a travel recommendation web site application, the runtime data 314 can include data about user clicks and page visits for a customer trying to book a trip using the web site.

Computational data 316 comprises data that is calculated or otherwise generated at runtime (for example, using an equation or algorithm). The outputs of the various neural networks 210 in the system 200 (also referred to here as “neural network outputs 322” or “neural outputs” 322) are one type of computational data 316 but other types of computational data 316 can be used. In a poker application, for example, a game theory calculation can be performed in some situations to determine the probability that “all players will fold if I raise”. Such a game-theory calculation, for example, could take neural network outputs 322 for each individual player and calculate the chances that all would fold based on those neural network outputs 322.

External data 318 comprises data directly obtained from outside of the analyzed environment 202 or the learning and analysis system 200. Examples of such data include the current weather, current exchange rate of the dollar, competitor's prices and the like. Other data 320 comprises any other useful data.

Historical data 312 comprises any of the foregoing data for previous points in time.

As shown in FIG. 3B, when the system 200 is used with discontinuous problem sets 206, each problem 204 within the discontinuous problem set 206 has its own problem-class model 300 and, when appropriate, neural networks 210. These individually created neural networks 210 are used by the predictive engine 208 to generate a solution for that problem 204.

As noted above, the solutions output for each of the problems 204 are included within the available parameters 308 for use by other problems 204. That is, the system 200 can use a hierarchy of problems 204 and problem sets 206 (and related problem-class models 300). A simple two-level hierarchy is shown in FIGS. 3C-3D in which the solutions for some lower-level problems 204 within a lower-level problem set 206 are used as parameters by a higher-level problem 204 within a higher-level problem set 206. Where the lower-level problems comprise discontinuous problems, the solutions for lower-level problems can be abstracted or scaled to create inputs for the higher-level problem. For example, where there are four lower-level discontinuous problems 204 (Mary, Jane, Tim, and Julie) that are being solved for weight, the generated weight solutions can be abstracted (where the possible negative effects of doing so are acceptable) to create a general weight value as an input to the higher-level problem 204 (for example, as illustrated in FIG. 3C) or the individual weight solutions can be used as separate parameters to the higher-level problem 204 (one for each lower-level problem 204) (for example, as illustrated as shown in FIG. 3D). The latter case, for example, can be used to find interdependencies among the lower-level problems 204. In addition, the four lower-level discontinuous problems 204 can also remain discontinuous in the higher-level problem 204 if they are each used as separate input parameters to the high-lever problem 204 and given a unique value (for example, −1 or 1) to signify if it is the particular person associated with the lower-level problem 204 or not (that is, a −1,−1,−1,−1” parameter set represents Mary, “−1, 1,−1,−1” represents Jane, “−1,−1, 1,−1” represents Tim, and “−1,−1,−1, 1” represents Julie). Such an approach, however, is typically only practical for relatively small discontinuous problem sets.

FIG. 4 is a flow chart of one embodiment of a method 400 of creating and training a neural network. The embodiment of method 400 shown in FIG. 4 is described here as being implemented using the system 200 of FIG. 2, though it is to be understood that other embodiments are implemented in other ways. In such an embodiment, the processing of method 400 is described here as being implemented by the learning engine 212 and the processing of method 400 is performed for each set of parameters that is associated with a particular problem 204 in the problem set 206. The embodiment of method 400 shown in FIG. 4 is described below relative to a particular set of parameters (referred to here as the “current” set of parameter”) associated with a particular problem 204 in the problem set 206 (referred to here as the “current” problem 204).

The learning engine 212 determines when there is sufficient data stored in the database 214 that is relevant to creating a neural network 210 for the current set of parameters (block 402). The relevant data that is used to create and train a neural network 210 for a given set of parameters is referred to here as the “exemplars” for the current set of parameters. Each exemplar for a particular set of parameters comprises, for a particular point in time, a value for each of the set parameters and the corresponding actual solution for the problem 204 at that point in time.

When there are a sufficient number of exemplars stored in the database 214 for the current set of parameters, the learning engine 212 retrieves the exemplars for the current set of parameters from the database 214 (block 404) and generate an initial neural network 210 for the current set of parameters (block 406). The initial neural network 210 is put in production for the current set of parameters (block 408). As used herein, “put into production” refers to storing the neural network 210 in the database 214 (on or in the associated data storage device 254) (and replacing any neural network 210 that was previously stored in the data storage device 254 for the current set of parameters). Once put into production, that neural network 210 is used by the predictive engine 208 (if and when described below) until a new neural network 210 is generated again or the neural network 210 is retrained as described below.

In one implementation of such an embodiment, the initial neural network 210 is generated by performing a genetic algorithm. In such an implementation, such a genetic algorithm starts by randomly creating a population of candidate neural networks for the current set of parameters, where each such candidate neural network uses the current set of parameters as its parameters. The random creation of the candidate neural networks involves randomly creating the various attributes of a neural network having the current set of parameters as its parameters (including, for example, network topology and the values assigned to various node weights). In each generation, each candidate neural network is trained with the retrieved exemplars and the fitness of each candidate neural network in the population is evaluated. One or more of the candidate neural networks are stochastically selected from the current population (based on their fitness) and modified (by recombining and possibly mutating) to form a new population for the next generation. The training, selection, regeneration is repeated a fixed number of times until a final generation is created that has a population that includes a single neural network. This single neural network 210 is then put in production for the current set of parameters (block 408). As used herein, “put into production” refers to storing the neural network 210 in the database 214 (on or in the associated data storage device 254) (and replacing any neural network 210 that was previously stored in the data storage device 254 for the current set of parameters). Once put into production, that neural network 210 is used by the predictive engine 208 (if and when described below) until a new neural network 210 is generated again or the neural network 210 is retrained as described below.

In another implementation of such an embodiment, the initial neural network 210 is generated by selecting an appropriate neural network topology or template, instantiating a neural network using the selected topology or template, and then training the instantiated neural network 210 using the available data. The appropriate neural network topology or template is selected, for example, by associating with each of multiple candidate neural network topologies or templates a priority and a selection condition. Then, the highest priority candidate neural network topology or template that has its associated selection condition satisfied is selected. Examples of selection conditions include conditions that require the associated problem (or set of parameters) to have a particular attribute or attributes.

In general, once an initial neural network 210 has been created for the current set of parameters, that neural network 210 is used in production until a new neural network 210 is generated for the current set of parameters (for example, by performing the genetic algorithm process described above again or by performing the template-selection process described above again). A new neural network 210 is generated again for the current set of parameters when a particular condition associated with the current set of parameters (referred to here as the “new neural network condition”) has been satisfied. In one implementation, the new neural network condition is satisfied when the system 200 obtains a predetermined number of new exemplars for the current set of parameters. Also, while a particular instantiation of a neural network 210 is being used by the system 200 for the current set of parameters, the learning engine 212 retrains that neural network 210 when another particular condition associated with the current set of parameters (referred to here as the “retrain condition”) is satisfied. In one implementation, the retrain condition is satisfied when the system 200 obtains a predetermined number of new exemplars for the current set of parameters (which is less than the number needed for the genetic algorithm condition to be satisfied). Moreover, for a particular application, the retrain condition may be dependent on the total number of exemplars stored in the database 214 for the associated set of parameters and/or on the number of times a neural network 210 has been generated for the associated set of parameters. That is, the retrain condition may be configured to retrain more frequently for the first few neural networks 210 that are generated for the associated set of parameters but retrain less frequently after a predetermined number of neural networks 210 have been generated for that set of parameters. Other retrain conditions can be used.

Therefore, after the processing described above in connection with blocks 402-408 has been initially performed, each time new data (that is, a new exemplar) that is relevant to the current set of parameters is obtained by the system 200 (block 410), the learning system 212 determines if the new neural network condition has been satisfied (block 412). If it has been satisfied, the learning engine 212 retrieves the exemplars for the current set of parameters from the database 214 (block 404) and generates new neural network 210 for the current set of parameters (block 406) as described above (for example, by performing the genetic algorithm processing or template-selection processing described above). Once new neural network 210 has been generated, the resulting generated neural network 210 is then used in production for the current set of parameters (block 408), until a new neural network 210 is generated again or the neural network 210 is retrained.

If the learning system 212 determines that the new neural network algorithm condition has not been satisfied, the learning system 212 determines if the retrain condition has been satisfied (block 414). If it has been satisfied, the learning system 212 retrieves the new exemplars for the current set of parameters (block 416) and then retrains the neural network 210 that is currently associated with the set of parameters using the retrieved new exemplars (block 418). The retrained neural network 210 is then used in production (block 420), until a new neural network is generated again or the neural network 210 is retrained again.

It should be noted that in the event that there is insufficient data to create any neural network 210 for the current problem 204, the predictive engine 208 uses an appropriate proxy to generate solutions for the current problem 204. In one implementation, the appropriate proxy that is used is determined by the rules engine 218 and the rules 220. For example, in one application, where the analyzed environment 202 comprises an on-line poker system, such a proxy may involve the use of a “default player” neural network 210 that is used in the event that the system does not have sufficient information about a particular player. Other proxies may be used (including, for example, non-neural-network based proxies).

It is should be noted that the retraining and recreation of new neural networks (for example, using a genetic algorithm) is performed at “run-time” while the system 200 is online and in production. As a result, the system 200 need not be taken “off-line” in order to learn or otherwise update its problem-solving models. Moreover, by automatically re-generating neural networks 210 while the system 200 is online, the system 200 is able to automatically adjust to changes in the analyzed environment.

FIG. 5 is a flow chart of one embodiment of a method 500 of generating a neural output for a problem. The embodiment of method 500 shown in FIG. 5 is described here as being implemented using the system 200 of FIG. 2 and neural networks 210 created and trained as described above in connection with FIG. 4; though, it is to be understood that other embodiments are implemented in other ways. In such an embodiment, the processing of method 500 is described here as being performed by the predictive engine 208 for each problem 204 in the problem set 206 when appropriate. The embodiment of method 500 shown in FIG. 5 is described below relative to one particular problem 204 (referred to here as the “current” problem 204) in a particular problem set 206.

In general, the method 500 makes use of an “auto-flexing” process in which the predictive engine 208, in order to generate a neural output for the current problem 204, selects from the neural outputs generated by those neural networks 210 that have been created and put into production for the current problem 204 as described above in connection with FIG. 4. Each of the set of parameters 306 has an associated “flex condition” that, when satisfied, indicates that the output of the associated neural network 210 is suitable for use by the predictive engine 208. For example, the flex condition may simply require that a suitably trained neural network 210 has been created and trained in accordance with FIG. 4. In another example, the neural network output produced by the neural network 210 associated with the set of parameters 306 must pass one or more sanity checks that ensures that the output is otherwise sensible or sane for the problem domain. Other flex conditions can be used. The predictive engine 208 selects the neural network 210 that has the most “appropriate” set of parameters for the current problem 204 that also has its associated flex condition satisfied. As used herein, the most appropriate set of parameters for the current problem refers to the set of parameters that will produce the most accurate output or result. In many applications, the most appropriate set of parameters for a problem will be the set of parameters with the most granular set of parameters.

More specifically and as shown in FIG. 5, when the predictive engine 208 determines that a neural output should be generated for the current problem 204 (checked in block 502), the predictive engine 208 determines if the flex condition for the most appropriate set of parameters for the current parameter 204 has been satisfied (block 504). If that is the case, the predictive engine 208 uses the neural output generated by that neural network 210 for the current problem 204 (block 506). Otherwise, the predictive engine 208 determines if the flex condition for the next-most appropriate set of parameters for the current parameter 204 has been satisfied (looping back to block 504) and, if that is the case, the predictive engine 208 uses the neural output generated by that neural network 210 for the current problem 204 (block 506). This process (blocks 504-506) is repeated until a suitable neural network 210 is selected or it is determined that there are no suitable neural network networks 210 for the current problem 204 (block 508).

In one implementation of such an embodiment, each neural network 210 for a given problem 204 generates a respective neural output in parallel and method 500 is performed in order to select which neural output to use as the neural output for the current problem 204 at that point in time. In another implementation, only the neural network 210 that is selected in accordance with method 500 generates a neural output at that point in time.

The auto-flexing process of method 500 enables the predictive engine 208 to automatically select the “best” neural network 210 at any given point in time to provide a neural output for the higher-level processing that is performed using such a neural output as an input. Moreover, the auto-flexing process can be used to automatically adjust the level at which the system 200 is attempting to solve the problem. For example, it may be the case that the neural network 210 associated with the most granular set of parameters 306 is not able to generate an appropriate neural network output (for example, because one of the parameters is not available or the resulting neural network output fails a “sanity check”), in which case the flex condition for that set of parameters 306 will not be satisfied and the system 200 will automatically try to use another set of parameters 306.

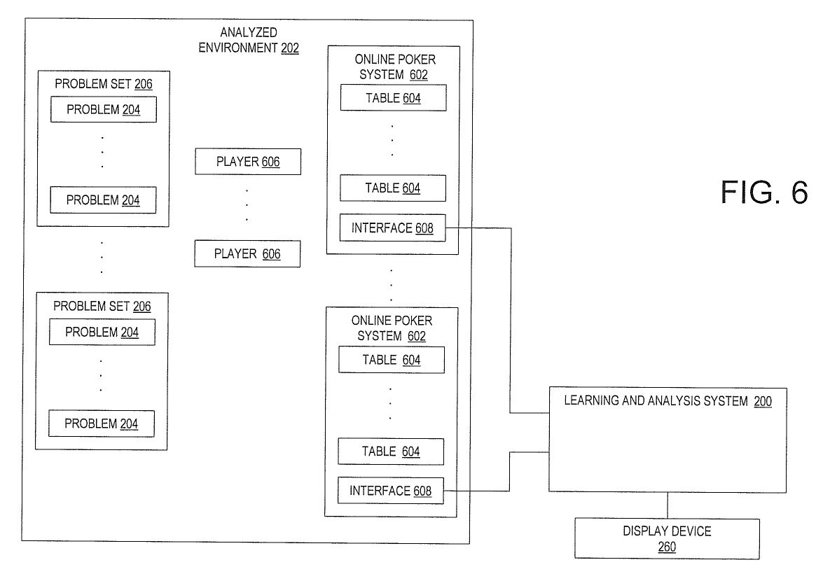

In one exemplary application (shown in FIG. 6), the analyzed environment 202 comprises one or more online poker systems 602, each of which typically has a plurality of tables 604, at each of which a plurality of players 606 play a game of poker. Embodiments of the system 200 are configured to generate outputs that comprise instantaneous, scenario-specific information and recommendations for a user of the system 200. This includes, for example, a recommendation as to what game-related action to take at that point in time (for example, “call”, “raise”, “fold”, “check”, or “bet”) and information indicating what game-related action the other players are expected to take. Such information can also include backward looking information such as to why an opponent took the game-related action that he or she did (for example, is the opponent bluffing when he or she raised?). Separate classes of problems can be established for each of these problems.

In such an application, the system 200 can be configured to capture as much information about each poker player known to the system 200 (for example, by capturing such game-related information from as many online poker systems or sites as possible and, preferably, continuously (that is, “24/7”). The system 200 then automatically creates and trains neural networks and generates neural network outputs for the player-specific problems using the techniques described above. In the example shown in FIG. 6, the system 200 uses an interface 608 provided by each of the online poker systems 602 to capture information about the poker games and players 606.

The player-specific neural network outputs can then be used as inputs (parameters) for higher-level problems (for example, problems that also include as inputs current pot size, odds, possible actions on future betting rounds, etc.). Examples of such higher-level problems include how each opponent can be expected to react to each possible game-related action the user of the system 200 could take at that time and, ultimately, what game-related action the user should take at that point in time.

Such an application of the system 200 has advantages over conventional poker strategy systems that merely provide generic player-information such as “this player raises 10% overall.” Such information typically has little strategic value because it cannot be applied directly to the current game situation. For example, it tells a user nothing about a particular game-related scenario—such as, the first player (who is a pro) raises, the second player (a very loose player) calls, the third player folds, and the fourth player (who raises 10% overall) raises. The user would have no idea if the 10% raise overall for the fourth player is an accurate gauge for this scenario and he or she is no better off for knowing about the 10% overall statistic. The system 200 described here, in contrast, can be configured to generate an output that informs the user how often the fourth player raises in this type of scenario and can predict the range of hands he holds when doing so.

Moreover, the system 200, in such an application, learns the style of each player as opposed to learning specific statistics for specific situations (that is, memorization). This is important since there are an infinite number of situations, making it unlikely one could define and provide statistics for all of them.

The outputs of the system 200 that are generated in such an application can be displayed on a display device 260 for a user of the system 200 to review, in response to which the user can take one or more game-related (or other) actions. In another example of such an application, the outputs of the system 200 that are generated cause one or more game-related actions to automatically occur (that is, without a human involvement) by having the system 200 communicate a command (or other data) directly to the online poker system (for example, using an interface 608 that the online poker provides).

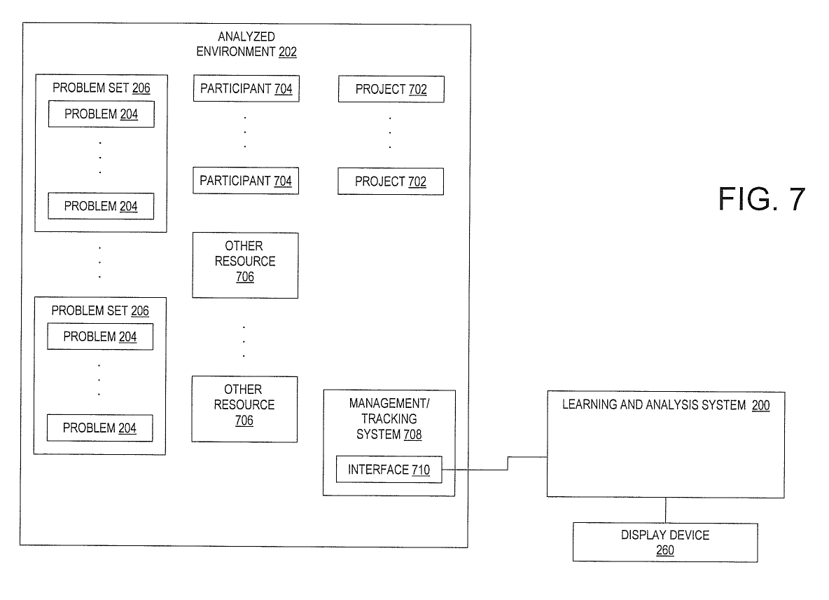

In another exemplary application (shown in FIG. 7), the analyzed environment 202 comprises a portfolio of projects 702 associated with an organization or person. Examples of such projects 702 include information technology development projects. Embodiments of the system 200, in such an application, generate outputs (using the techniques described above) that provide information related to, for example, expected results, expected time of completion, risks, critical breaches of policy, inappropriate resource and personnel assignments, and mismanagement and provide recommendations for pro-active actions to be taken to remedy and prevent problems and to maximize the success of each such project.

Technology development projects often encounter many obstacles to successful completion. Almost every technology development project encounters major problems of some type, and many are severely delayed, have huge cost overruns, or fail to deliver on promised functions or benefits. A significant percentage of all information technology (IT) development projects fail disastrously and never reach conclusion. Today, executives typically have no system that provides effective project portfolio management, and thus executives typically do not have the ability to effectively oversee the myriad of projects for which they are responsible. They do not know which ones will be on time, whether resources are properly aligned, which will deliver promised return on investment, etc. The problem is that individual projects and the interaction of multiple projects is an inherently complex operation with many moving parts. It is not intuitive to understand how one action will affect the entire portfolio.

The system 200 (and the techniques described above) can be used to address these issues because the system 200 can be configured to sort out the complexities, understand the key moving parts, and/or provide recommendations at all levels. Similar principles are used as with the online poker application described above. To provide effective portfolio management, the system 200, in such an application, starts with individual project participants 704 (for example, programmers or engineers). Individual problems are defined for each individual participant 704 (thereby, creating a discontinuous problem set) to predict if each such participant will meet deadlines and produce quality work product (for example, quality code in the case of programmers). The system 200 can be configured to do this by tracking key parameters for each such participant including but not limited to: check in time, check out time, hours worked, project stage, skill levels, type of work, complexity, number of errors, type of errors, severity of errors, lines of code delivered, quality of specifications, understanding of specifications, number of specification changes, who their manager is, etc. These, and other factors, enable the system 200 to gauge the progress and quality of work product developed by each project participant and to make accurate predictions and recommendations over the remaining project timeframe.

Each participant 704, in such an application, has his own problem and one or more separate neural networks are generated using, for example, the genetic algorithm techniques discussed above. This is important in this application because each participant may have a different work style and the resulting neural networks will need to be finely tuned to each participant. For example, in one illustration, a user of the system 200 may be configured to generate an output that provides an alert when it appears that a particular participant will ultimately deliver bad work product (for example, bad software code). A naive, conventional approach might simply determine the number of errors in the software code per day and whenever it is over a predetermined threshold provide an alert. However, such a conventional approach will typically not work effectively because some developers may develop very slowly and carefully and check their work as they go while others may use an iterative process where they develop the bulk framework quickly and then refine it over time through many iterations and refinements. To make it even more complex, certain participants may mutate their style depending on time available, complexity, etc. Also, the issue may not be in the errors at all. For example, a specific participant working more than 8 hours per day at a late stage in a project may signify a huge pending problem even if his code is error free. The system 200 and the techniques described above can be used to learn the style of each participant, in the same general manner as is done in the online poker application described above to learn the style of each poker player. In such an application, the system 200 generates outputs that provide instantaneous, scenario-specific recommendations and information.

Once the participant-specific problems are solved (that is, appropriate neural network outputs are generated for each participant-specific problem that is defined), the system 200 can be configured to use such solutions to provide alerts to deviations from the normal style and provide alerts to problems or situations where the participant is ahead of schedule. Advantageously, in such an application, the system 200 can be configured to solve higher-level problems. The system 200 can be configured take participant-specific neural network outputs and use them as inputs to higher-level problems, such as team-related problems, development-group-related problems, project-related problems, portfolio-of-projects related problems, etc. In such an application, the system 200 can be configured to make recommendations and provide information across all portfolio projects relating to, for example, resource levels, assignment of resources, audits, extension/reduction of timeframes, meetings, budget levels, development approaches, etc. In such an application, other resources 706 can be tracked by the system 200.

The outputs of the system 200 that are generated in such an application can be displayed on a display device for a user of the system 200 to review, and in response to which the user can take one or more project-related (or other) actions. In another example of such an application, the outputs of the system 200 that are generated cause one or more project-related actions to automatically occur (that is, without a human involvement) by having the system 200 communicate a command (or other data) directly to an appropriate system or device. For example, the system 200 can be configured to use the generated outputs to cause emails to be sent out and/or to cause other project management or resource management systems 708 to be updated or changed using an appropriate interface 710 provided by such systems 708. Also, relevant input information can be captured by the system 200, for example, from such other project management/tracking or resource management/tracking systems 708 using such interface 710. Such input information can be capture in other ways.

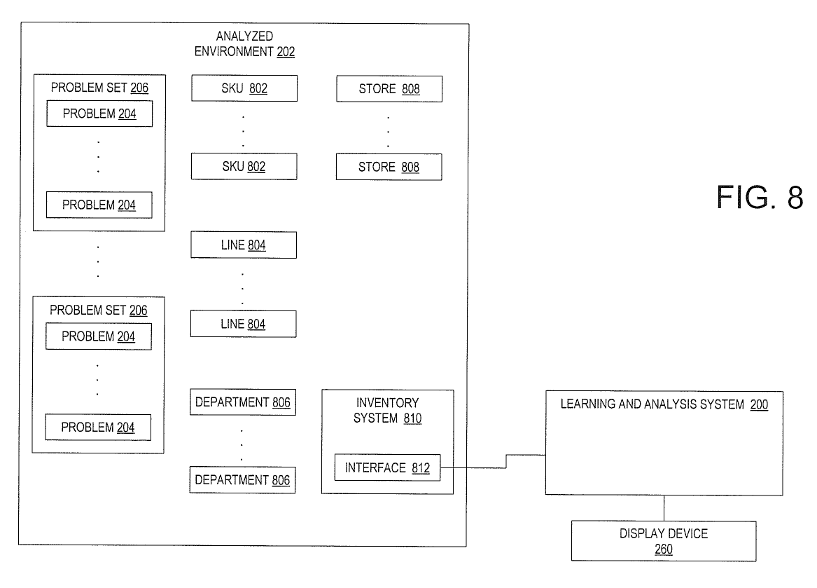

In another exemplary application (shown in FIG. 8), the analyzed environment 202 comprises one or more of retail sales, retail profitability, retail inventory, wholesale sales, wholesale profitability, and wholesale inventory. Embodiments of the system 200, in such an application, generates outputs (using the techniques described above) that provide recommendations for optimizing profitability at the store, department, merchandise line, and/or stock keeping unit (SKU) level and information related to, for example, product-pricing, product market downs over time, inventory levels (for example, on a per-store and/or per-warehouse basis) purchase timing and quantities, and product offerings.

Those involved in the retail business typically address issues with maintaining appropriate inventory levels (on a per-store and per-warehouse basis), appropriately pricing product, and determining when to markdown product. Historically, retailers's projections are frequently incorrect. Embodiments of the system 200 (and the techniques described above) can be configured to address such issues.

Similar principles are used as with the online poker and project portfolio applications described above. In this application, the system 200 is configured to solve low-level problems associated with individual SKUs 802. If a particular SKU-specific problem has enough exemplary data, a granular neural network 210 can be created, trained, and used to generate a SKU-specific solution. If not, the auto-flexing and proxy techniques described above can be used so that less granular neural networks 210 can be created, trained, and used or an appropriate non-neural-network proxy can be used. For example, neural networks 210 or proxies that are more abstract can be used, such as neural networks 210 that have parameters that take into account SKU type (for example, dress, shoes), color, style, etc. In addition to historical data, the system 200 can be configured to use other real-time current data as parameters for the various neural networks 210 that are created and trained. For example, in a particular store and at a particular time, the color red may be “hot” with consumers. In such a scenario, problems that make use of a color-related parameter (input) enables outputs to be generated to predict which SKUs will likely be affected by such a trend and make recommendations accordingly (for example, by adjusting price or inventory levels). The system 200 captures information related to SKUs 802, product lines 804, departments 806, and stores 808, for example, from an existing inventory or pricing system 810 using an appropriate interface 812.

In such an application, the system 200 can be configured to solve higher-level problems that use outputs generated for lower-level problems as inputs (for example, SKU-specific problems). Examples of such higher-level problems include interactions across SKUs, departments, stores, etc. The system 200 can also be configured to solve even higher-level problems that use solutions to lower-level problems to set optimal pricing, inventory allocation, purchasing, across all SKUS in a particular group (such as, company, store, department, product type, etc).

The outputs of the system 200 that are generated in such an application can be displayed on a display device for a user of the system 200 to review, and in response to which the user can take one or more related actions. In another example of such an application, the outputs of the system 200 that are generated cause one or more related actions to automatically occur (that is, without a human involvement) by having the system 200 communicate a command (or other data) directly to an appropriate system or device. For example, the system 200 is configured to use the generated outputs to cause emails to be sent out and/or to cause other inventory or pricing management systems 808 to be updated or changed using interface 810.

In such an application, the system 200 can be configured to have auditing capabilities to provide alerts and to prevent the system 200 from accidentally mispricing (for example, to prevent the system 200 from generating outputs that cause a normally ten-dollar item to be priced at fifty cents). Also, the system 200 can be configured to use game theory data to “watch” competitor stores, factor in parameters based on the competitors, and make calculations and optimal decisions based on game theory optimal play against such competitors.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Data storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A system for analyzing an analyzed environment, the system comprising:
at least one programmable processor to execute a plurality of program instructions; and
at least one data storage device communicatively coupled to the at least one programmable processor to store a plurality of neural networks, each of the plurality of neural networks having an associated set of parameters; and
wherein the program instructions, when executed, are operable to cause the at least one programmable processor to:
associate a respective plurality of sets of parameters with each of a plurality of problems associated with the analyzed environment;
automatically generate a respective neural network for each set of parameters associated with each of the problems when there is sufficient data to do so; and
generate a solution for at least one problem by selecting a neural network from the neural networks that are associated with the at least one problem and by using a neural network output output by the selected neural network in order to generate the solution for the at least one problem.

2. The system of claim 1, wherein the respective neural network for each set of parameters associated with each of the problems is automatically generated using a genetic algorithm when there is sufficient data to do so.

3. The system of claim 1, wherein the respective neural network for each set of parameters associated with each of the problems is automatically generated, when there is sufficient data to do so, by selecting a neural network template, instantiating the respective neural network using the selected neural network template, and training the instantiated respective neural network.

4. The system of claim 1, wherein the program instructions, when executed, are operable to cause the at least one programmable processor to, for each current neural network stored in the at least one data storage device, automatically generate a respective new neural network and store the respective new neural network in the at least one data storage device in place of the respective current neural network.

5. The system of claim 4, wherein for each current neural network stored in the at least one data storage device, the respective new neural network is generated when a predetermined condition associated with the set of parameters associated with the respective current neural network is satisfied.

6. The system of claim 1, wherein the program instructions, when executed, are operable to cause the at least one programmable processor to, for each current neural network stored in the at least one data storage device, retrain the current neural network and store the respective retrained neural network in the at least one data storage device in place of the respective current neural network.

7. The system of claim 6, wherein for each current neural network stored in the at least one data storage device, the respective current neural network is retrained when a predetermined condition associated with the set of parameters associated with the respective current neural network is satisfied.

8. The system of claim 1, wherein the program instructions, when executed, are operable to cause the at least one programmable processor to, generate a solution for the at least one problem by selecting, from the neural networks that are associated with the at least one problem, the neural network that has the most appropriate set of parameters associated therewith and that has an associated flex condition that is satisfied, and by using a neural network output output by the selected neural network in order to generate the solution for the at least one problem.

9. The system of claim 8, wherein the neural network that has the most appropriate set of parameters associated therewith comprises the neural network that has the most granular set of parameters associated therewith.

10. The system of claim 1, wherein the system generates an output based on at least one solution to one problem.

11. The system of claim 10, wherein the system further comprises an interface to communicate at least a portion of the output to a display device for display thereon.

12. The system of claim 10, wherein the system further comprises an interface to communicate at least a portion of the output to an interface associated with the analyzed environment in order to cause an action associated with the analyzed environment to be taken.

13. The system of claim 1, wherein the analyzed system comprises multiple classes of problems.

14. The system of claim 13, wherein each class of problems has an associated class of parameters, wherein each class of parameters has an associated plurality of sets of parameters.

15. The system of claim 13, wherein solutions to problems included in a first class of problems are used as parameters for problems included in a second class of problems.

16. The system of claim 1, wherein the plurality of problems comprises a set of discontinuous problems.

17. The system of claim 1, wherein the at least one data storage device comprises at least one of: volatile memory, non-volatile memory, magnetic disc storage device, and an optical disc storage device.

18. The system of claim 1, wherein the at least one data storage device comprises a plurality of data storage devices.

19. The system of claim 1, wherein the system comprises a plurality of programmable processors.

20. The system of claim 1, wherein the plurality of program instructions comprises a plurality of separate items of software.

21. The system of claim 20, further comprising a plurality of programmable processors, wherein different items of software are executed on different programmable processors.

22. The system of claim 1, wherein parameters available to be used for the neural networks are stored in the at least one data storage device.

23. The system of claim 22, wherein the parameters available to be used for the neural networks comprise historical data and current data.

24. The system of claim 22, wherein the parameters available to be used for the neural networks comprise at least one of: runtime data, computational data, external data, neural network outputs, other data, and game-theory data.

25. The system of claim 1, wherein the analyzed environment comprises at least one of an online poker system, a travel-related reservation system, a portfolio of projects, retail sales, retail profitability, retail inventory, wholesale sales, wholesale profitability, and wholesale inventory.

26. A method for analyzing an analyzed environment, the method comprising:
storing a plurality of neural networks in at least one data storage device, each of the plurality of neural networks having an associated set of parameters; and
associating a respective plurality of sets of parameters with each of a plurality of problems associated with the analyzed environment;
generating a respective neural network for each set of parameters associated with each of the problems when there is sufficient data to do so; and
generating a solution for at least one problem by selecting a neural network from the neural networks that are associated with the at least one problem and by using a neural network output output by the selected neural network in order to generate the solution for the at least one problem.

27. The method of claim 26, wherein generating a respective neural network for each set of parameters associated with each of the problems when there is sufficient data to do so comprises using a genetic algorithm to generate the respective neural network for each set of parameters associated with each of the problems when there is sufficient data to do so.

28. The method of claim 26, wherein generating a respective neural network for each set of parameters associated with each of the problems when there is sufficient data to do so comprises selecting a neural network template, instantiating the respective neural network using the selected neural network template, and training the instantiated respective neural network.

29. The method of claim 26, further comprising, for each current neural network stored in the at least one data storage device, generating the respective new neural network and storing the respective new neural network in the at least one data storage device in place of the respective current neural network.

30. The method of claim 29, wherein for each current neural network stored in the at least one data storage device, the respective new neural network is generated when a predetermined condition associated with the set of parameters associated with the respective current neural network is satisfied.

31. The method of claim 30, further comprising, for each current neural network stored in the at least one data storage device, retraining the current neural network and storing the respective retrained neural network in the at least one data storage device in place of the respective current neural network.

32. The method of claim 31, wherein for each current neural network stored in the at least one data storage device, the respective current neural network is retrained when a predetermined condition associated with the set of parameters associated with the respective current neural network is satisfied.

33. The method of claim 26, wherein a solution is generated for the at least one problem by selecting, from the neural networks that are associated with the at least one problem, the neural network that has the most appropriate set of parameters associated therewith and that has an associated flex condition that is satisfied, and by using a neural network output output by the selected neural network in order to generate the solution for the at least one problem.

34. The method of claim 33, wherein the neural network that has the most appropriate set of parameters associated therewith comprises the neural network that has the most granular set of parameters associated therewith.

35. The method of claim 26, wherein the plurality of problems comprises a set of discontinuous problems.

36. The method of claim 26, wherein the analyzed environment comprises at least one of an online poker system, a travel-related reservation system, a portfolio of projects, retail sales, retail profitability, retail inventory, wholesale sales, wholesale profitability, and wholesale inventory.

37. A program product for analyzing an analyzed environment, tangibly stored on a computer-readable medium, comprising instructions operable to cause at least one programmable processor to:
store a plurality of neural networks in at least one data storage device, each of the plurality of neural networks having an associated set of parameters; and
associate a respective plurality of sets of parameters with each of a plurality of problems associated with the analyzed environment;
generate a respective neural network for each set of parameters associated with each of the problems when there is sufficient data to do so; and
generate a solution for at least one problem by selecting a neural network from the neural networks that are associated with the at least one problem and by using a neural network output output by the selected neural network in order to generate the solution for the at least one problem.

38. The program product of claim 37, wherein the respective neural network for each set of parameters associated with each of the problems is automatically generated using a genetic algorithm when there is sufficient data to do so.

39. The program product of claim 37, wherein the respective neural network for each set of parameters associated with each of the problems is automatically generated, when there is sufficient data to do so, by selecting a neural network template, instantiating the respective neural network using the selected neural network template, and training the instantiated respective neural network.

40. The program product of claim 37, further comprising instructions operable to cause the at least one programmable processor to, for each current neural network stored in the at least one data storage device, use the genetic algorithm to generate a respective new neural network and store the respective new neural network in the at least one data storage device in place of the respective current neural network.

41. The program product of claim 40, wherein for each current neural network stored in the at least one data storage device, the respective new neural network is generated when a predetermined condition associated with the set of parameters associated with the respective current neural network is satisfied.

42. The program product of claim 37, further comprising instructions operable to cause the at least one programmable processor to, for each current neural network stored in the at least one data storage device, retrain the current neural network and store the respective retrained neural network in the at least one data storage device in place of the respective current neural network.

43. The program product of claim 42, wherein for each current neural network stored in the at least one data storage device, the respective current neural network is retrained when a predetermined condition associated with the set of parameters associated with the respective current neural network is satisfied.

44. The program product of claim 37, wherein a solution is generated for the at least one problem by selecting, from the neural networks that are associated with the at least one problem, the neural network that has the most appropriate set of parameters associated therewith and that has an associated flex condition that is satisfied, and by using a neural network output output by the selected neural network in order to generate the solution for the at least one problem.

45. The program product of claim 44, wherein the neural network that has the most appropriate set of parameters associated therewith comprises the neural network that has the most granular set of parameters associated therewith.

46. The program product of claim 37, wherein the plurality of problems comprises a set of discontinuous problems.

47. The program product of claim 37, wherein the analyzed environment comprises at least one of an online poker system, a travel-related reservation system, a portfolio of projects, retail sales, retail profitability, retail inventory, wholesale sales, wholesale profitability, and wholesale inventory.

48. A system for analyzing an analyzed environment, the system comprising:
means for storing a plurality of neural networks in at least one data storage device, each of the plurality of neural networks having an associated set of parameters; and
means for associating a respective plurality of sets of parameters with each of a plurality of problems associated with the analyzed environment;
means for generating a respective neural network for each set of parameters associated with each of the problems when there is sufficient data to do so; and
means for generating a solution for at least one problem by selecting a neural network from the neural networks that are associated with the at least one problem and by using a neural network output output by the selected neural network in order to generate the solution for the at least one problem.
